(19) United States
(12) Patent Application Publication
(10) Pub. No.: US 2019/0057572 A1
(43) Pub. Date: Feb. 21, 2019

(54) METHOD OF SELECTING A CONTEST WINNER

(71) Applicant: R. Jay Carpenter, Phoenix, AZ (US)

(72) Inventor: R. Jay Carpenter, Phoenix, AZ (US)

(21) Appl. No.: 16/166,084

(22) Filed: Oct. 20, 2018

(51) Int. Cl. G07F 17/32

(52) U.S. Cl. CPC G07F 17/329

(57) ABSTRACT

A method is disclosed that provides a secure and easily auditable drawing for a contest winner. The disclosed method includes A) computing a participant hash for each participant, B) selecting a portion of the participant hash, C) determining a participant numerical value based on the portion of the participant hash for each participant, D) selecting an external information source, E) determining an external hash based on the external source of information, F) selecting a portion of the external hash, G) determining an external numerical value based on the portion of the external hash and H) determining a contest winner by comparing the participant numerical values with the external numerical value.

### BACKGROUND

### 1. Technical Field

This disclosure relates to contests, games of chance, raffles lottery systems, drawings or other systems where one winner or recipient or a small group of winners or recipients are selected from a larger group.

### 2. Background Art

Drawings to award prizes have been done with many different methods including the participating group placing a name in a hat and one person drawing a name out of the hat. As contests and drawings have grown to include larger groups and groups from different locations, different methods of entering a drawing contest have been used such as using a computer to randomly select one of the entries or one of the potential recipients. In some cases the selection process is broadcast live to create excitement and entertainment and so that those who have entered the contest can determine if they are a winner, or recipient of a prize.

Satoshi Dice is a game where the input from the user, along with a secret that is not known to the user, is combined to create a hash, and the hash outcome is used as the random number to give a result and determine whether a reward is given. As with other drawings or contests, there is a third party that must be trusted with a secret or with a key. If the trust of the third party is violated, the contest no longer becomes fair.

One prior system discloses a method of administering a game of chance in patent application publication US2012-0149453 A1 filed by inventor Leo DiBenigno and others. DiBenigno discusses the challenge of requiring security and accounting personnel when the winning numbers of a game of chance are drawn. The cost of security and accounting personnel is highest when the numbers are regularly drawn throughout the day, such as in a bingo or Keno game. DiBenigno proposes a solution by having the winning numbers for an entire day drawn before the start of the day, and then stored in an encrypted manner on a server until the designated time of the drawing.

One of the challenges with prior methods of selecting winners is trust in the people or systems that are selecting winners of the contest. When names are drawn out of a hat, the people must trust the person drawing the name, that they are not using slight of hand or a trick, and that the selection is truly random. The same is true for a computer program to select a winner. The participants in the contest must trust that the people programming the computer and running the contest are actually selecting a random participant or random result. Because of the concerns about tampering with the results of a contest, many contest exclude those who are administering the contest as eligible for the prize or prizes of the contest. In some instances investigations have found that millions of dollars of prizes were awarded to people connected to the administration of a contest. The investigation of crimes and the lost confidence of the participants in a contest are significant costs resulting from insecure contests and methods of determining a winner in a drawing or contest.

### BRIEF SUMMARY

A method is disclosed that provides a secure and easily auditable drawing for a contest winner. The disclosed method includes

A) computing a participant hash for each participant,
B) selecting a portion of the participant hash,
C) determining a participant numerical value based on the portion of the participant hash for each participant,
D) selecting an external information source,
E) determining an external hash based on the external source of information
F) selecting a portion of the external hash
G) determining an external numerical value based on the portion of the external hash and
H) determining a contest winner by comparing the participant numerical values with the external numerical value.

### BRIEF DESCRIPTION OF THE DRAWINGS

FIG. 1 is a flow chart for a process to select the winner of a contest.

FIG. 2 is an example user interface for operating the method of selecting the winner of a contest.

FIG. 3 is an example spreadsheet that may be used in a system for selecting the winner of a contest.

### DETAILED DESCRIPTION

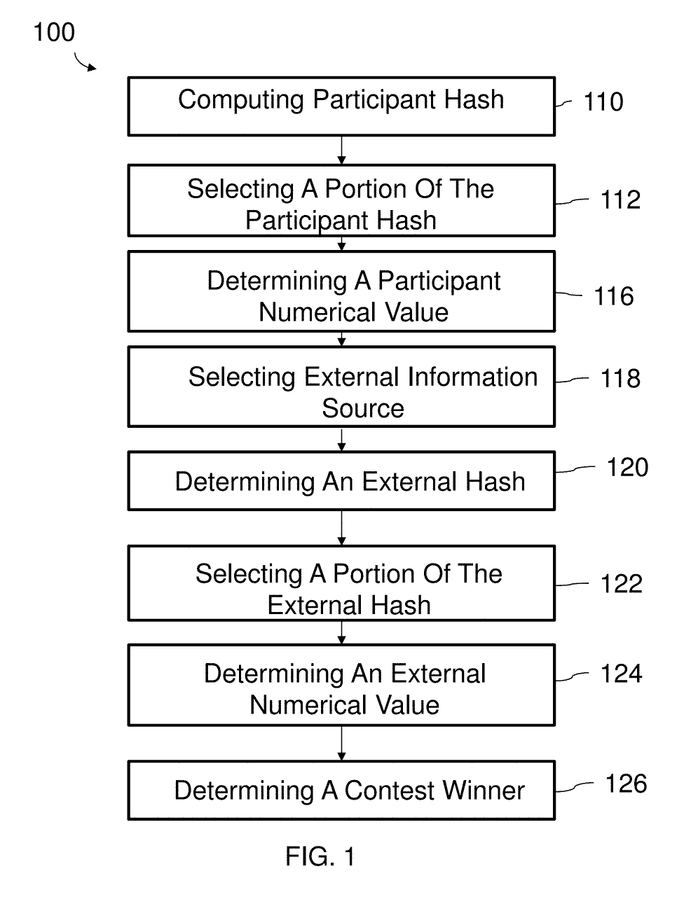

Each of the method steps of the disclosed method will be discussed in relation to examples described in this disclosure. FIG. 1 shows a method 100 of selecting a contest winner.

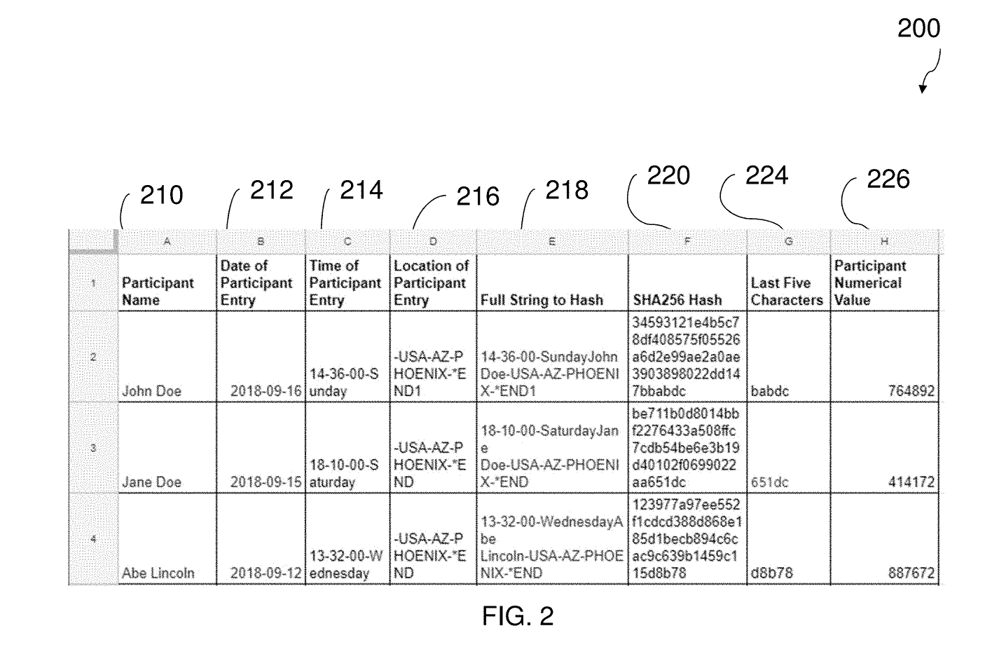

Participant information may be gathered through any system, for example an online registration or contest entry system. FIG. 2 shows an example spreadsheet 200 with information gathered and computed for participants. The information gathered may include a participant name 210, Date of participant entry 212, Time of Participant Entry 214, and location of participant entry 216, which may be a location based on the IP address that the participant uses. In the example a participant hash is computed 110 from a string 218 that includes the time of participant entry 214, the date of participant entry 212, the participant name 210 and the location of participant entry 218. The participant hash 220 may be created using a SHA256 hash. The step of computing a participant hash 110 may be performed for each participant.

In the example the next step is selecting a portion of the participant hash 112, in this case the last 5 hexadecimal digits 224 of the SHA256 participant hash are selected. With the selected portion of the participant hash, the step of determining a participant numerical value 116 may be based on the portion of the participant hash 224 for each participant. On method of determining a participant numerical value 226 may be to convert the last five hash characters 224 from hexadecimal to a base 10 number. Another way to determine a participant numerical value 226 may be to convert each of the five hexadecimal characters to text numbers and the 5 text numbers may be added to determine a participant numerical value. Whatever method is used consistently for all participants can allow a random number assignment to a participant, or to a participant entry if a participant has multiple entries.

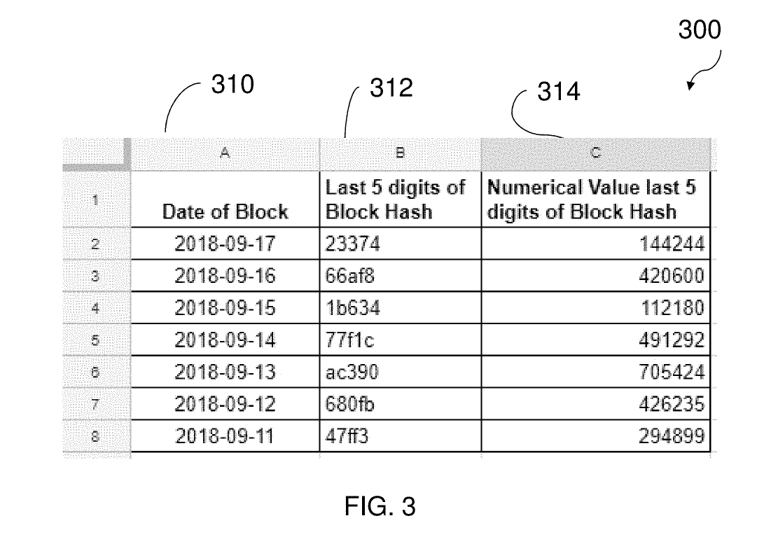

Selecting an external information source 118, may include selecting the hash of a blockchain such as Bitcoin or another cryptocurrency. In an example the external source is chosen as the hash of a block that is closest in time to a specific date and time, such as 12:00 PM eastern standard time. FIG. 3 shows an external source table 300 where the block date 310 of the hash for a block at the designated time is entered with the last five digits of the block hash 312, and also the block hash numerical value 314.

Determining an external hash based on the external source of information 120 may be performed by selecting a future external hash that will occur after the close of all contest entries. In an example the contest has daily prize winners, and the participants for a daily prize drawing are determined at midnight prior to the drawing of the prize winner. In this example no new contest entries can be submitted after midnight, and all the participant numerical values 226 can be determined at midnight for the drawing or prize. The selected external source may be based on the hash of a blockchain block that is closest to noon of the following day, or twelve hours after the contest closes. This method of selecting an external source may prevent anyone from manipulating the block hash numerical value 314 that will determine the winner. It is desirable to select an external information source that has a high volume inputs from a large number of sources so that one person or a small group of people cannot influence the outcome of the block hash numerical value 314.

The external information source may also be a combination of sources. For example multiple cryptocurrencies can be used and the block hash from multiple cryptocurrencies may be combined to create the block hash numerical value. The selection of the external source may be predetermined and programmed into a system so that the block hash numerical values is automatically determined. It is desirable for the external information source to be a publicly accessible information source so that anyone interested in auditing the results of the drawing may do so. It is also desirable for the computation method to be revealed to participants and auditors such as the method of selecting a portion of the external hash 122, and the method of determining an external numerical value 124, such as the block hash numerical value 314 based on the portion of the external hash. The method of determining a contest winner 126 may also be announced to the participants and auditors. For example determining a contest winner 126 may include comparing the participant numerical values 226 with the block hash numerical value 314 to determine which of the participant numerical values 226 is closest to the block hash numerical value 314.

In an example, the method of selecting a contest winner 100 was used to select a winner of a daily prize. Participants were entered into the drawing for the daily prize when they meet the qualifications for the drawing. In this case the participants were required to be members of a group, and the name of the participant 210 and the date 212 and time 214 that they joined the group were entered and stored on a spreadsheet 200. Participants signed up using the internet, and their location was determined based on the IP address used to access the website used to join the group. the location of the participant entry 216 was also entered on the spreadsheet 200. A string was created using the participant name, date, time and location. A participant may be given access to the string 218 used to create their own hash so that they can verify their own participant hash 220. As an option, a participant may enter ascii character text that can also be added to the string of characters. Participant addition to a string to hash may reduce the possibility of someone using a publicly available hash to determine their personal information. Other random information or characters may also be added to a string to create the participant hash.

Participants may also be given access to the participant hash 220 for all of the participants. A participant cannot use a hash to determine the original string, as a hash is a one-way function. This would allow all participants to have confidence in the result of the contest as they could see, or record for later audit, all of the hash entries for the contest before the block hash numerical value is determined. This would mean that the only way for someone to manipulate the outcome is to manipulate the external block hash because all of the inputs are fixed prior to the final determination of the external block hash. The external block hash would be difficult to manipulate and it would be very highly unlikely that manipulation would be successful.

The value of the prize may guide a contest facilitator to determine the type and manner of determining the external numerical value 124. For example a multi-million dollar contest may utilize the results from multiple cryptocurrencies or other external sources, and create a hash from the results of the multiple external sources, making it nearly impossible for someone to manipulate the outcome. While on the other hand, if the prize were valued at less than one-hundred dollars, a contest facilitator may determine that a single external source may be sufficient to prevent manipulation of the outcome.

With either a large value prize or a low dollar prize, the disclosed method may allow all involved parties, interested third parties, and regulators to obtain all the information to audit the results easily and at a very low cost. Such an easily auditable contest is likely to prevent fraud and manipulation of a contest, and encourage participants to join in the contest with confidence in the result. Participants may also be able to rely on the protection of their personal information as each participant entry (where a single participants may have multiple entries) will result in a hash for a participant hash that can be audited without the participant's information being revealed.

While the principles of the invention have been made clear in illustrative embodiments, there will be immediately obvious to those skilled in the art (or technology area) many modifications of structure, arrangement, proportions, and methods, the elements, materials, and components used in the practice of the invention, and otherwise, which are particularly adapted to specific environments and operative requirements without departing from those principles.

What is claimed is:

1. A method according to the description disclosed in this application.
